(19) United States
(12) Patent Application Publication
(10) Pub. No.: US 2013/0166171 A1
(43) Pub. Date: Jun. 27, 2013

(54) System and Method for Controlling an Engine Speed Limit of a Work Vehicle During a Transmission Ratio Change

(71) Applicants: Brian A. Hartman, Valparaiso, IN (US); Pawel Kuros, Wood Dale, IL (US)

(72) Inventors: Brian A. Hartman, Valparaiso, IN (US); Pawel Kuros, Wood Dale, IL (US)

(73) Assignee: CNH AMERICA LLC, New Holland, PA (US)

(21) Appl. No.: 13/332,645

(22) Filed: Dec. 21, 2011

(51) Int. Cl. B60W 10/06

(52) U.S. Cl. 701/102

(57) ABSTRACT

A method for controlling the speed limit of an engine of a work vehicle during a transmission ratio change is disclosed. The method may generally include receiving with a controller signals associated with an input speed and an output speed of a transmission of the work vehicle, determining a percent ratio change between a first gear ratio and a second gear ratio of the transmission as a function of the input and output speeds as the transmission is shifted from the first gear ratio to the second gear ratio, determining a target engine speed limit for the engine based on the percent ratio change and adjusting an actual engine speed limit of the engine based on the target engine speed limit as the transmission is shifted from the first gear ratio to the second gear ratio.

### FIELD OF THE INVENTION

The present subject matter relates generally to work vehicles and, more particularly, to a system and method for controlling the engine speed limit of a work vehicle during a transmission ratio change.

### BACKGROUND OF THE INVENTION

Work vehicles employ transmissions that are quite different than those used in standard passenger cars. In work vehicles, the power to weight ratio is typically much more limited than in automobiles, which means that the engine of a work vehicle is usually running at or near capacity during most of its operation. As a result, shifting within the transmission of a work vehicle, particularly for ground engaging work vehicles (e.g., tractors towing plows), is critical. Specifically, shifting must occur rapidly and with very little delay from the time power is disengaged from the drive wheels to the time power is reengaged to the drive wheels. This rapid disengagement and reengagement permits work vehicles to change gears much more rapidly than is possible in standard automobiles.

Typically, a work vehicle transmission (e.g., a power shift transmission) includes a large number of gears capable of providing a plurality of different gear ratios. For example, work vehicle transmissions may include 8, 10 or even 20 forward gears. With this many forward gears, work vehicles spend a significant amount of time shifting from one gear ratio to another to optimize vehicle speed and engine load. However, when the gear ratio is changed, the speed limit of the engine may also need to be changed to ensure that the ground speed of the work vehicle is maintained at or below the overall speed limit set for such vehicles by applicable state and/or country regulations/laws.

As is generally understood, a work vehicle transmission may have a predetermined engine speed limit for each selected gear ratio to ensure that the work vehicle do not exceed the overall speed limit. Accordingly, when gear ratios are changed rapidly within the transmission, the engine speed limit is also changed rapidly. Such rapid changing of the engine speed limit often results in a very abrupt shift that can be felt by the operator of the work vehicle. This is particularly true when the ratio change is performed, not to increase/decrease the ground speed of the work vehicle, but, instead, to simply reduce the engine speed in order to increase vehicle efficiency at the same ground speed.

Accordingly, a system and method for controlling the engine speed limit of a work vehicle during a transmission ratio change that provides a smooth transition between gear ratios would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter discloses a method for controlling the speed limit of an engine of a work vehicle during a transmission ratio change. The method may generally include receiving with a controller signals associated with an input speed and an output speed of a transmission of the work vehicle, determining a percent ratio change between a first gear ratio and a second gear ratio of the transmission as a function of the input and output speeds as the transmission is shifted from the first gear ratio to the second gear ratio, determining a target engine speed limit for the engine based on the percent ratio change and adjusting an actual engine speed limit of the engine based on the target engine speed limit as the transmission is shifted from the first gear ratio to the second gear ratio.

In another aspect, the present subject matter discloses a work vehicle having a control system for controlling engine speed limits during transmission ratio changes. The work vehicle may generally include an engine and a transmission coupled to the engine. The transmission may have a first gear ratio and a second gear ratio. In addition, the work vehicle may include a first sensor configured to detect an input speed of the transmission, a second sensor configured to detect an output speed of the transmission and at least one controller communicatively coupled to the first and second sensors. The at least one controller may be configured to determine a percent ratio change between the first and second gear ratios as a function of the input and output speeds as the transmission is shifted from the first gear ratio to the second gear ratio, determine a target engine speed limit for the engine based on the percent ratio change and adjust an actual engine speed limit of the engine based on the target engine speed limit as the transmission is shifted from the first gear ratio to the second gear ratio.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of a work vehicle;

FIG. 2 illustrates a schematic, top view of one embodiment of a control system for a work vehicle, particularly illustrating the control system's interconnection to the engine and transmission of the work vehicle; and

FIG. 3 illustrates a flow diagram of one embodiment of a method for controlling the engine speed limit of a work vehicle during a transmission ratio change.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter discloses a system and method for controlling the engine speed limit of a work vehicle during a transmission ratio change. Specifically, in several embodiments, the engine speed limit may be adjusted based on a target engine speed limit that is continuously calculated by a controller(s) of the work vehicle during the transmission ratio change, wherein the target engine speed limit varies as a function of the changing gear ratio. By determining a target engine speed limit that is proportional to the effective gear ratio during the transmission ratio change, the engine speed limit of a work vehicle may be adjusted in a gradual, controlled manner so as to minimize the effect felt by an operator of such work vehicle during the ratio change.

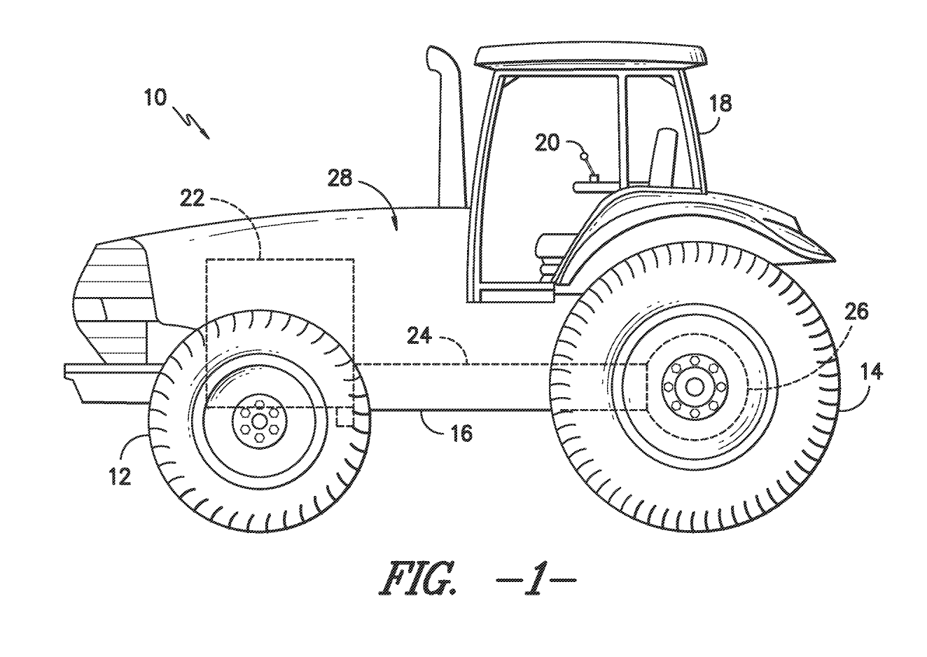

Referring now to the drawings, FIG. 1 illustrates a side view of one embodiment of a work vehicle 10. As shown, the work vehicle 10 is configured as an agricultural tractor. However, in other embodiments, the work vehicle 10 may be configured as any other suitable work vehicle known in the art, such as various other agricultural vehicles, earth-moving vehicles, road vehicles, loaders and/or the like.

As shown in FIG. 1, the work vehicle 10 includes a pair of front wheels 12, a pair or rear wheels 14 and a chassis 16 coupled to and supported by the wheels 12, 14. An operator's cab 18 may be supported by a portion of the chassis 16 and may house various control devices 20 (e.g., levers, pedals, control panels and/or the like) for permitting an operator to control the overall operation of the work vehicle 10. Additionally, the work vehicle 10 may include an engine 22 and a transmission 24 mounted on the chassis 16. The transmission 24 may be operably coupled to the engine 22 and may provide variably adjusted gear ratios for transferring engine power to the wheels 14 via a differential 26. The engine 22, transmission 24, and differential 26 may collectively define a drive train 28 of the work vehicle 10.

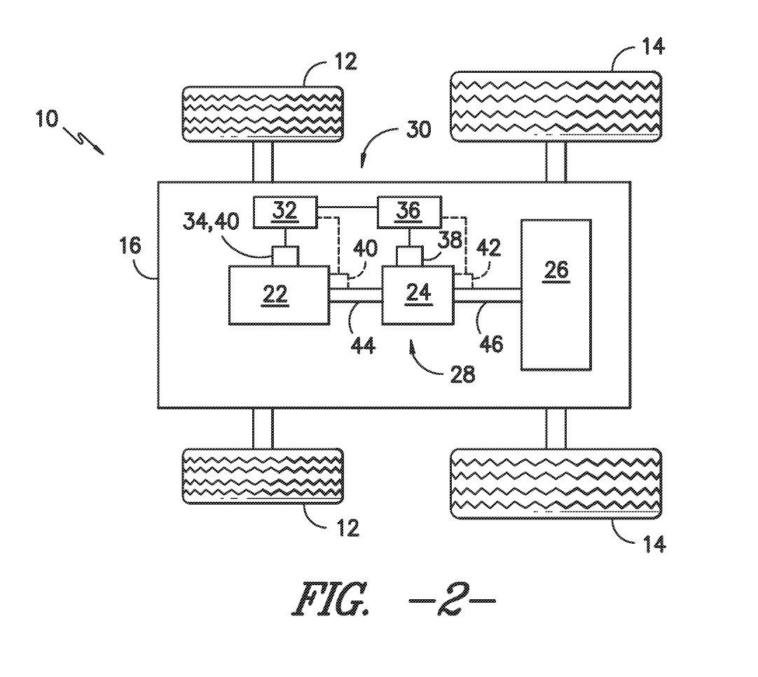

It should be appreciated that the transmission 24 may generally comprise any suitable transmission known in the art having a plurality of different, fixed gear ratios. For example, in several embodiments, the transmission 24 may comprise a multispeed power shift transmission having a plurality of selectable gear ratios (e.g., a plurality of selectable forward and reverse gear ratios) and a plurality of internal clutches (e.g., hydraulically actuated clutches) that may be selectively actuated in order to engage the transmission in the differing gear ratios. In such embodiments, the clutches may be configured to be automatically engaged within the transmission 24 via the vehicle control system 30 described below with reference to FIG. 2 (e.g., by transmitting control signals from a controller of the vehicle control system 30 to suitable actuators configured to engage/disengage the clutches).

It should also be appreciated that the configuration of the work vehicle 10 described above and shown in FIG. 1 is provided only to place the present subject matter in an exemplary field of use. Thus, it should be appreciated that the present subject matter may be readily adaptable to any manner of work vehicle configuration 10. For example, in an alternative embodiment, a separate frame or chassis may be provided to which the engine 22, transmission 24, and differential 26 are coupled, a configuration common in smaller tractors. Still other configurations may use an articulated chassis to steer the work vehicle 10, or rely on tracks in lieu of the wheels 12, 14.

Referring now to FIG. 2, a schematic, top view of one embodiment of a vehicle control system 30 that may be utilized to control one or more of the components of a work vehicle 10 is illustrated in accordance with aspects of the present subject matter. As shown, the vehicle control system 30 may include an engine controller 32 configured to control the operation of the engine 22. For instance, the engine controller 32 may be communicatively coupled to an engine governor 34 in order to control and/or monitor the speed of the engine 22. As such, in several embodiments of the present subject matter, the engine controller 32 may be configured to transmit suitable control signals to the engine governor 34 in order to decrease/increase the engine speed in order to satisfy any engine speed limits applied to the engine 22 through the engine controller 32. For example, the engine governor 34, in response to the control signals, may adjust the fuel flow rate by transmitting a suitable signal to the fuel injectors of the engine 22, adjust the flow of air to each combustion chamber of the engine 22 and/or the like to decrease/increase the engine speed.

In addition, the vehicle control system 30 may also include a transmission controller 36 configured to control the operation of the transmission 24. For example, in several embodiments, the transmission controller 36 may be communicatively coupled to a transmission valve manifold 38 to permit the controller 36 to selectively engage the transmission 24 in any of its forward and reverse gear ratios. Specifically, as is generally understood, the transmission valve manifold 38 may include a plurality of hydraulic valves (not shown) configured to control engagement and/or disengagement of the internal clutches of the transmission 24. As such, the transmission controller 36 may be configured to transmit suitable control signals to the transmission valve manifold 38 in order to selectively engage/disengage the clutches of the transmission 24, thereby permitting the transmission controller 36 to automatically adjust the gear ratio of the transmission 24.

It should be appreciated that the vehicle control system 30 may also be configured to control the operation of various other components of the work vehicle 10. For example, one embodiment, a controller of the control system 30 may be communicatively coupled to a steering manifold (not shown) of the work vehicle 10 to control steering of the wheels 12, 14.

Additionally, in several embodiments, the vehicle control system 30 may be coupled to one or more speed sensors 40, 42 for monitoring the input speed and/or the output speed of the transmission 24. For example, as shown in FIG. 2, the engine controller 32 and/or the transmission controller 36 may be communicatively coupled to a first speed sensor 40 configured to monitor the engine speed (i.e., the transmission input speed). In one embodiment, the first speed sensor 40 may comprise the engine governor 34. For instance, as is generally understood, an engine governor 34 typically includes an internal speed sensor configured to measure the rotational speed of the engine 22. In another embodiment, the first speed sensor 40 may comprise a separate speed sensor (shown in dashed lines), such as a shaft sensor or other suitable speed sensor, configured to directly or indirectly monitor the engine speed. For example, the separate speed sensor may be coupled to an input shaft 44 of the transmission 24. Alternatively, the separate speed sensor may be configured to monitor the rotational speed of the engine 22 by detecting fluctuations in the electric output of an engine alternator (not shown) of the work vehicle 10, which may then be correlated to the engine speed.

Moreover, as shown in FIG. 2, the engine controller 32 and/or the transmission controller 36 may be communicatively coupled to a second speed sensor 42, such as a shaft sensor or other suitable speed sensor, configured to directly or indirectly monitor the transmission output speed. For example, the second speed sensor 42 may be coupled to an output shaft 46 of the transmission 26, such as by being mounted to an output gear (not shown) of the transmission 26. Alternatively, the second speed sensor 42 may be disposed at any other suitable location, such as within the differential 26.

It should be appreciated that the engine controller 32 may be coupled to the transmission controller 25 via a CAN bus or other suitable communicative link. As such, control signals generated by either controller 32, 36 and/or measurement signals provided by the speed sensors 40, 42 may be transmitted between the controllers 32, 36.

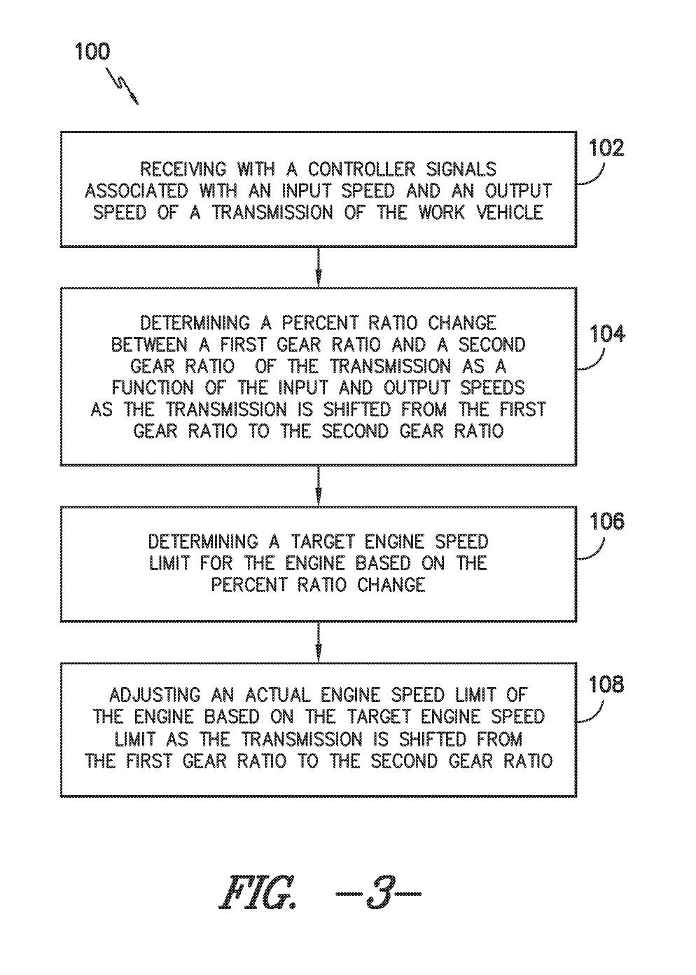

It should also be appreciated that each controller 36, 32 may generally comprise any suitable computer and/or other processing unit. Thus, in several embodiments, each controller 36, 32 may include one or more processor(s) and associated memory device(s) configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) of each controller 32, 36 may generally comprise memory element(s) including, but are not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the controllers 32, 36 to perform various computer-implemented functions, such as by performing the steps and/or calculations of the method described below with reference to FIG. 3. In addition, the controllers 32, 36 may also include various other suitable components, such as a communications circuit or module, one or more input/output channels for receiving input signals (e.g., from the speed sensors 40, 42) and/or for transmitting control signals, a data/control bus coupling the components of the controllers 32, 36 together and/or the like.

Referring now to FIG. 3, a flow diagram of one embodiment of a method 100 for controlling the engine speed limit of an engine of a work vehicle during a transmission ratio change is illustrated in accordance with aspects of the present subject matter. As shown, the method 100 may generally include receiving with a controller signals associated with an input speed and an output speed of a transmission of the work vehicle 102, determining a percent ratio change between a first gear ratio and a second gear ratio of the transmission as a function of the input and output speeds as the transmission is shifted from the first gear ratio to the second gear ratio 104, determining a target engine speed limit for the engine based on the percent ratio change 106 and adjusting an actual engine speed limit of the engine based on the target engine speed limit as the transmission is shifted from the first gear ratio to the second gear ratio 108. It should be appreciated that, although the method elements 102, 104, 106, 108 of the disclosed method 100 are shown in a particular order in FIG. 3, the method elements may generally be performed in any suitable order that is consistent with the disclosure provided herein.

In general, the disclosed method 100 allows for the engine speed limit of a work vehicle 10 to be adjusted during a transmission ratio change in a controlled manner so as to minimize the effect felt by an operator of such work vehicle 10 during the ratio change. Specifically, as the work vehicle 10 is shifted between a first gear ratio and a second gear ratio, the speed limit for the engine 22 may be adjusted during the shift based on the difference between the gear ratios and a measured ratio through the transmission 24 (i.e., the ratio between the output speed and the input speed of the transmission 24). In other words, the engine speed limit may be increased or decreased as a function of the effective gear ratio during the shift, thereby resulting in a smooth transition between the transmission gear ratios.

It should be appreciated by those of ordinary skill in the art that the disclosed method 100 may be particularly advantageous during transmission ratio changes in which the engine 22 is speed-limited in the current gear ratio and will also need to be speed-limited in the new gear ratio in order to maintain the ground speed of the work vehicle 10 at or below the speed limit set of such work vehicle 10 by applicable state and/or country regulations/laws. For instance, implementation of the disclosed method 100 may be particularly advantageous when a transmission ratio change is performed, not to increase/decrease the ground speed of the work vehicle 10, but, instead, to simply reduce the engine speed in order to achieve a higher efficiency (e.g., a higher fuel efficiency) at the same ground speed. However, it should be appreciated that the disclosed method 100 may also be advantageously applied during any other transmission ratio change of a work vehicle 10 to provide a smooth transition between the gear ratios.

As shown in FIG. 3, in 102, one or more of the controllers 32, 36 of the work vehicle 10 may receive signals associated with the input speed and the output speed of the transmission 24. For instance, as indicated above, the engine controller 32 and/or the transmission controller 36 may be communicatively coupled to both a first speed sensor 40 configured to detect the input speed of the transmission 24 (i.e., the engine speed) and a second speed sensor 42 configured to detect the output speed of the transmission 24. In addition, as described above, the controllers 32, 36 may be communicatively to the one another. Accordingly, measurement signals associated with the input and output speeds of the transmission 24 may be transmitted from the speed sensors 40, 42 to one or both of the controller(s) 32, 36.

By receiving the measurement signals from the speed sensors 40, 42, the engine controller 32 and/or the transmission controller 36 may be capable of determining an effective or measured gear ratio through the transmission 24. Specifically, in several embodiments, the measured gear ratio through the transmission 25 may be determined using the following equation:

$$M G R = ( \frac{T O S}{TIS} ) \qquad ( equation 1 )$$

wherein, MGR corresponds to the measured gear ratio through the transmission 24, TOS corresponds to the output speed of the transmission 24 and TIS corresponds to the input speed of the transmission 24.

It should be appreciated that the measured gear ratio may continuously change while a transmission ratio change is occurring. Thus, the speed sensors 40, 42 may be configured to monitor the input and output speeds of the transmission 24 at a given sampling rate (e.g., every 10 milliseconds), thereby permitting the controller(s) 32, 36 to continuously calculate the measured gear ratios through the transmission 24 during the period of the transmission ratio change (e.g., during a period of 1-3 seconds).

Referring still to FIG. 3, in 104, a percent ratio change between a first gear ratio and a second gear ratio of the transmission 24 is determined as a function of the input and output speeds as the transmission 24 is shifted from the first gear ratio to the second gear ratio. It should be appreciated that, as used herein, the terms “first gear ratio” and “second gear ratio” are generically used to identify the gear ratio of the transmission 24 prior to a transmission ratio change (i.e., the first gear ratio) and the gear ratio of the transmission 24 after such transmission ratio change (i.e., the second gear ratio). Thus, the first and second gear ratios may correspond to any of the gear ratios of the transmission 24. For instance, when up-shifting, the first gear ratio may correspond to the gear ratio at a lower gear of the transmission 24 and the second gear ratio may correspond to the gear ratio at a higher gear of the transmission 24. Similarly, when down-shifting, the first gear ratio may correspond to the gear ratio at a higher gear of the transmission 24 and the second gear ratio may correspond to the gear ratio at a lower gear of the transmission 25.

In general, the percent ratio change between the first and second gear ratios may be determined based on the measured gear ratios (equation (1)) calculated while the transmission 24 is shifted from the first gear ratio to the second gear ratio. For example, in several embodiments, the percent ratio change may be determined using the following equation:

$$\% R C = ( \frac{\frac{T O S}{TIS} - GR 1}{GR 2 - GR 1} ) \qquad ( equation ( 2 ) )$$

wherein, % RC corresponds to the percent ratio change, TOS corresponds to the output speed of the transmission 24, TIS corresponds to the input speed of the transmission 24, GR1 corresponds to the first gear ratio and GR2 corresponds to the second gear ratio.

It should be appreciated that, by using the measured gear ratio as an input, the percent ratio change may also vary as the transmission 24 is shifted between the first and second gear ratios. Thus, in several embodiments, the engine controller 32 and/or the transmission controller 36 may be configured to continuously calculate the percent ratio change as the shift occurs. For instance, as is generally understood, the gear ratio for each gear of the transmission 24 (e.g., GR1 and GR2) may be known and, thus, may be stored within the memory of the controller(s) 32, 36. Accordingly, for each set of input/output speed measurements provided by the speed sensors 40, 42 during the shift, the controller(s) 32, 36 may be configured to calculate a corresponding percent ratio change using equation (2).

Referring still to FIG. 3, in 106, a target engine speed limit for the engine 22 may be determined based on the percent ratio change. Specifically, for each percent ratio change calculated by the controller(s) 32, 36 as the transmission 24 is shifted between the first gear ratio and the second gear ratio, the controller(s) 32, 36 may also be configured to determine a target engine speed limit. For instance, in several embodiments, the controller(s) 32, 36 may be configured to determine the target engine speed limit for the engine 22 using the following equation:

TESL=ESL1−% RC*(ESL1−ESL2) (equation (3))

wherein TESL corresponds to the target engine speed limit, % RC corresponds to the percent ratio change, ESL1 corresponds to a predetermined engine speed limit for the first gear ratio and ESL2 corresponds to a predetermined engine speed limit for the second gear ratio.

It should be readily appreciated by those of ordinary skill in the art that predetermined engine speed limits are typically assigned to each gear ratio of a work vehicle transmission 24. For instance, in several embodiments, the engine speed of a work vehicle 10 may be limited to a predetermined value for each gear ratio so that the corresponding ground speed of the work vehicle 10 at each gear ratio does not exceed the overall speed limit set for such vehicle 10 by applicable state and/or country regulations/laws. Accordingly, in several embodiments of the present subject matter, the predetermined engine speed limits for each gear ratio of the transmission 24 (e.g., ESL1 and ESL2) may be known and, thus, may be stored within the memory of the controller(s) 32, 36. As such, for each percent ratio change calculated by the controller(s) 32, 36 during the time period in which the transmission ratio change is occurring, the controller(s) 32, 36 may be configured to calculate a corresponding target engine speed limit using equation (3).

It should also be appreciated that the target engine speed limit calculated according to equation (3) may generally fall between the predetermined engine speed limit for the first gear ratio and the predetermined engine speed limit for the second gear ratio as the transmission is being shifted between the first and second gear ratios. However, when the transmission 24 is fully engaged at the second gear ratio, the target engine speed limit may generally be equal to the predetermined engine speed limit set for the second gear ratio. For example, when the gear corresponding to the second gear ratio is fully engaged within the transmission 24, the measured gear ratio (equation (1)) may be substantially equal to the second gear ratio. As such, the percent ratio change may be equal to 1 and, using equation 3, the target engine speed limit would be equal to the predetermined engine speed limit for the second gear ratio.

In addition, in 108 of the disclosed method 100, an actual speed limit of the engine 22 may be adjusted based on the target engine speed limit as the transmission 24 is shifted from the first gear ratio to the second gear ratio. In particular, to provide a smooth transition between the first and second gear ratios, the actual engine speed limit applied to the engine 22 (via the engine governor 34) may be adjusted so as to be at or below the target engine speed limit at all times during the ratio change. For instance, in several embodiments, the actual engine speed limit may be incrementally adjusted as the transmission 24 is shifted from the first gear ratio to the second gear ratio, such as by limiting the rate of change of the actual speed limit by a predetermined rate. As such, the actual engine speed limit may be gradually adjusted from the predetermined speed limit set for the first gear ratio towards the target engine speed limit calculated by the controller(s) 32, 36 during the transmission ratio change.

In several embodiments, the predetermined rate at which the actual engine speed limit is adjusted during the ratio change may range from about 20 revolutions-per-minute per second (RPM/second) to about 200 RPM/second, such as from about 40 RPM/second to about 150 RPM/second or from about 60 RPM/second to about 120 RPM/second and all other subranges therebetween. Thus, at the low end of the range, the actual speed limit of the engine 22 may be increased/decreased towards the target engine speed limit by 20 RPM every second during the transmission ratio change.

Additionally, in several embodiments, the predetermined rate may vary depending on whether the actual engine speed limit is being increased or decreased during the ratio change (i.e., depending on whether the target engine speed limit is above or below the predetermined speed limit set for the first gear ratio). For example, in one embodiment, the predetermined rate may range from about 20 RPM/second to about 60 RPM/second when the actual engine speed limit is being increased, such as from about 30 RPM/second to about 50 RPM/second or from about 35 RPM/second to about 45 RPM/second and all other subranges therebetween. Similarly, in one embodiment, the predetermined rate may range from about 130 RPM/second to about 170 RPM/second when the actual engine speed limit is being decreased, such as from about 140 RPM/second to about 160 RPM/second or from about 145 RPM/second to about 155 RPM/second and all other subranges therebetween.

Moreover, as indicated above, the target engine speed limit may generally correspond to the predetermined engine speed limit set for the second gear ratio when the gear corresponding to the second gear ratio is fully engaged within the transmission 24. Thus, in several embodiments, the actual engine speed limit may be controlled based on such predetermined engine speed limit once the transmission 24 has been fully shifted to the second gear ratio. For instance, in one embodiment, the actual engine speed limit may be adjusted to the predetermined engine speed limit as soon as the transmission 24 has been fully shifted to the second gear ratio. Alternatively, the actual engine speed limit may continue to be adjusted according the predetermined rate described above until the predetermined engine speed limit set for the second gear ratio is reached.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for controlling the speed limit of an engine of a work vehicle during a transmission ratio change, the method comprising:
receiving with a controller signals associated with an input speed and an output speed of a transmission of the work vehicle;
determining a percent ratio change between a first gear ratio and a second gear ratio of the transmission as a function of the input and output speeds as the transmission is shifted from the first gear ratio to the second gear ratio;
determining a target engine speed limit for the engine based on the percent ratio change; and
adjusting an actual engine speed limit of the engine based on the target engine speed limit as the transmission is shifted from the first gear ratio to the second gear ratio.

2. The method of claim 1, wherein adjusting an actual engine speed limit of the engine based on the target engine speed limit as the transmission is shifted from the first gear ratio to the second gear ratio comprises incrementally adjusting the actual engine speed limit towards the target engine speed limit at a predetermined rate as the transmission is shifted from the first gear ratio to the second gear ratio.

3. The method of claim 2, wherein the predetermined rate ranges from about 20 RPM/second to about 200 RPM/second.

4. The method of claim 3, wherein the predetermined rate ranges from about 20 RPM/second to about 60 RPM/second when the actual engine speed limit is being increased.

5. The method of claim 3, wherein the predetermined rate ranges from about 130 RPM/second to about 170 RPM/second when the actual engine speed limit is being decreased.

6. The method of claim 1, wherein receiving with a controller signals associated with an input speed and an output speed of a transmission of the work vehicle comprises receiving at least one signal from a first sensor configured to monitor the input speed of the transmission and receiving at least one signal from a second sensor configured to monitor the output speed of the transmission.

7. The method of claim 1, wherein determining a percent ratio change between a first gear ratio and a second gear ratio of the transmission as a function of the input and output speeds as the transmission is shifted from the first gear ratio to the second gear ratio comprises determining the percent ratio change according to the equation:
$$\% R C = ( \frac{\frac{T O S}{TIS} - GR 1}{GR 2 - GR 1} )$$
wherein, % RC corresponds to the percent ratio change, TOS corresponds to the output speed of the transmission, TIS corresponds to the input speed of the transmission, GR1 corresponds to the first gear ratio and GR2 corresponds to the second gear ratio.

8. The method of claim 1, wherein determining a target engine speed limit for the engine based on the percent ratio change comprises determining the target engine speed limit according to the equation:
TESL=ESL1−% RC*(ESL1−ESL2)
wherein TESL corresponds to the target engine speed limit, % RC corresponds to the percent ratio change, ESL1 corresponds to a predetermined engine speed limit for the first gear ratio and ESL2 corresponds to a predetermined engine speed limit for the second gear ratio.

9. The method of claim 1, further comprising adjusting the actual engine speed limit based on a predetermined engine speed limit for the second gear ratio after the transmission is shifted to the second gear ratio.

10. The method of claim 9, wherein adjusting the actual engine speed limit based on a predetermined engine speed limit for the second gear ratio after the transmission is shifted to the second gear ratio comprises incrementally adjusting the actual engine speed limit towards the predetermined engine speed limit at a predetermined rate after the transmission is shifted to the second gear ratio.

11. A work vehicle having a control system for controlling engine speed limits during transmission ratio changes, the work vehicle comprising:
an engine;
a transmission coupled to the engine, the transmission having a first gear ratio and a second gear ratio;
a first sensor configured to detect an input speed of the transmission;
a second sensor configured to detect an output speed of the transmission; and
at least one controller communicatively coupled to the first and second sensors, the at least one controller being configured to determine a percent ratio change between the first and second gear ratios as a function of the input and output speeds as the transmission is shifted from the first gear ratio to the second gear ratio, determine a target engine speed limit for the engine based on the percent ratio change and adjust an actual engine speed limit of the engine based on the target engine speed limit as the transmission is shifted from the first gear ratio to the second gear ratio.

12. The vehicle of claim 11, wherein the first sensor comprises an engine governor of the engine.

13. The vehicle of claim 11, wherein the first sensor is coupled to an input shaft of the transmission.

14. The vehicle of claim 11, wherein the second sensor is coupled to an output shaft of the transmission.

15. The vehicle of claim 11, wherein the at least one controller is further configured to incrementally adjust the actual engine speed limit towards the target engine speed limit at a predetermined rate as the transmission is shifted from the first gear ratio to the second gear ratio.

16. The vehicle of claim 15, wherein the predetermined rate ranges from about 20 RPM/second to about 200 RPM/second.

17. The vehicle of claim 11, wherein the at least one controller is configured to determine the percent ratio change according to the equation:
$$\% R C = ( \frac{\frac{T O S}{TIS} - GR 1}{GR 2 - GR 1} )$$
wherein, % RC corresponds to the percent ratio change, TOS corresponds to the output speed of the transmission, TIS corresponds to the input speed of the transmission, GR1 corresponds to the first gear ratio and GR2 corresponds to the second gear ratio.

18. The vehicle of claim 11, wherein the at least one controller is configured to determine the target engine speed limit according to the equation:
TESL=ESL1−% RC*(ESL1−ESL2)
wherein TESL corresponds to the target engine speed limit, % RC corresponds to the percent ratio change, ESL1 corresponds to a predetermined engine speed limit for the first gear ratio and ESL2 corresponds to a predetermined engine speed limit for the second gear ratio.

19. The vehicle of claim 11, wherein the at least one controller is further configured to adjust the actual engine speed limit based on a predetermined engine speed limit for the second gear ratio after the transmission is shifted to the second gear ratio.

20. The vehicle of claim 19, wherein the at least one controller is configured to incrementally adjust the actual engine speed limit towards the predetermined engine speed limit at a predetermined rate after the transmission is shifted to the second gear ratio.
